(19) United States
(12) Patent Application Publication
(10) Pub. No.: US 2018/0029652 A1
(43) Pub. Date: Feb. 1, 2018

(54) ARRANGEMENT FOR COUPLING MAIN FRAME WITH EQUALIZER BAR OF A MACHINE

(71) Applicant: Caterpillar Inc., Peoria, IL (US)

(72) Inventors: Vijay Loganathan, Bloomington, IL (US); Florentin Tatarus, Peoria, IL (US); Kelly Ann Scholz, Peoria, IL (US); Gail Francis Westendorf, Decatur, IL (US)

(73) Assignee: Caterpillar Inc., Peoria, IL (US)

(21) Appl. No.: 15/219,318

(22) Filed: Jul. 26, 2016

(51) Int. Cl. B62D 55/084; B62D 55/10

(52) U.S. Cl. CPC B62D 55/0842; B62D 55/10; B60G 2204/418; B60G 2300/32

(57) ABSTRACT

An arrangement for pivotally coupling a saddle member of a main frame with an equalizer bar of a machine. The saddle member includes one or more bores. The equalizer bar includes a central portion. The arrangement includes a pin and one or more bearings. The pin extends through each of the one or more bores and couples the saddle member with the central portion of the equalizer bar. The one or more bearings positioned inside each of the one or more bores for rotatably supporting the pin.

### TECHNICAL FIELD

The present disclosure generally relates to coupling of an equalizer bar with a main frame of a machine, and in particular, to coupling the main frame with the equalizer bar by one or more bearings.

### BACKGROUND

Machines, such as track type machines, typically include a main frame supported on an undercarriage. An equalizer bar is commonly used to allow a degree of flexibility in movement of the undercarriage relative to the main frame. A central portion of the equalizer bar is pivotally coupled to the main frame by a pin, while either ends of the equalizer bar are connected with the undercarriage.

Generally, the pin is press-fit into a bore of the frame and a corresponding bore of the equalizer bar. Because machines operate in rugged conditions, the pin may be exposed to external environment and may become corroded over time. Thus, the pin may become jammed inside the bore and is difficult to be removed at the time of servicing. In certain situations, for removing the pin, the pin may need to be cut or lanced out. This makes the associated service operation labor intensive and time consuming.

U.S. Pat. No. 7,861,413 discloses an elastomeric bearing assembly for use with the equalizer link of a tractor and an associated pin structure for securing the elastomeric bearing assembly and the equalizer link to the roller frame assembly of the tractor.

### SUMMARY OF THE INVENTION

The present disclosure provides for an arrangement for pivotally coupling an equalizer bar with a saddle member of a main frame of a machine. The saddle member includes one or more bores. The equalizer bar includes a central portion. The arrangement includes a pin and one or more bearings. The pin extends through each of the one or more bores and couples the saddle member with the central portion of the equalizer bar. The one or more bearings positioned inside each of the one or more bores for rotatably supporting the pin.

The present disclosure further provides for an assembly. The assembly includes a main frame, an equalizer bar, a first bearing, a second bearing, and a pin. The main frame includes a laterally-extending saddle member having a first bore and a second bore. The equalizer bar includes a third bore. The first bore, second bore and the third bore are alignable along a first axis with the third bore positioned between the first bore and the second bore. The first bearing is positioned within the first bore. The second bearing is positioned within the second bore. The pin extends in the first axis and at least partially extends in each of the first bearing, the third bore, and the second bearing.

In yet another aspect, a machine is disclosed. The machine includes a main frame including a laterally-extending saddle member having one or more bores, an undercarriage supporting the main frame, an equalizer bar including a central portion and a pair of distal end portions, a pin, and one or more bearings. The central portion pivotally couples to the saddle member and the pair of distal end portions couple to the undercarriage. The one or more bearings are positioned inside each of the one or more bores. The pin extends through each of the one or more bores for coupling the main frame with the central portion of the equalizer bar.

### BRIEF DESCRIPTION OF THE DRAWINGS

FIG. 1 illustrates a side view of a machine, in accordance with an embodiment;

FIG. 2 illustrates an assembly of the machine having a main frame with a saddle member, in accordance with an embodiment;

FIG. 3 illustrates an exploded view of the assembly depicting the saddle member, an equalizer bar, and one or more bearings, in accordance with an embodiment;

FIG. 4 illustrates the assembly depicting the saddle member coupled with the equalizer bar, in accordance with an embodiment;

FIG. 5 illustrates a perspective view of the one or more bearings, in accordance with an embodiment; and

FIG. 6 illustrates a cross-sectional view of an arrangement depicting a pin coupling the saddle member with the equalizer bar, in accordance with an embodiment.

### DETAILED DESCRIPTION

Reference will now be made in detail to embodiments of the invention, examples of which are illustrated in the accompanying drawings. Wherever possible, the same reference numbers will be used throughout the drawings to refer to the same or like parts.

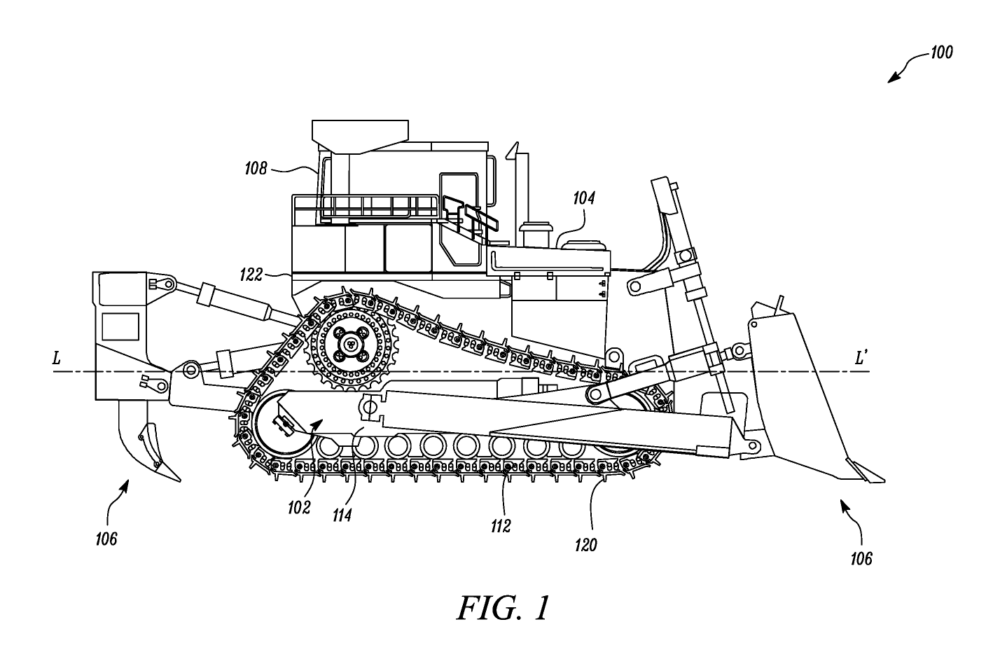

FIG. 1 illustrates an exemplary machine 100. The machine 100 defines a longitudinal axis LL′. The machine 100 may include a track-type machine or a wheel-type machine. The machine 100 may include loaders, compactors, dozers, excavators, or any other suitable machine. The machine 100 may be an earth moving machine, a construction machine, a mining machine, an agricultural machine, a forest machine, etc. In the illustrated embodiment, the machine 100 is a dozer. However, those skilled in the art would appreciate that the scope of the disclosure is not limited to the machine 100 as the dozer.

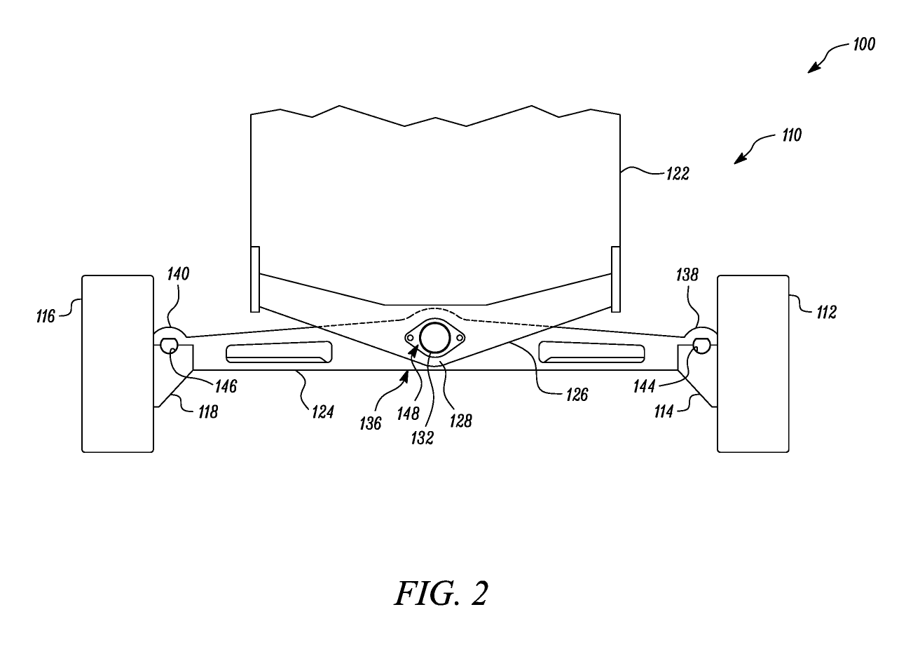

Referring to FIGS. 1 and 2, the machine 100 includes an undercarriage 102, an engine 104, an implement 106, an operator station 108, and an assembly 110. The undercarriage 102 may include a first track 112 supported on a first track frame 114, and a second track 116 supported on a second track frame 118. The first track 112 and the second track 116 include a plurality of track shoes 120. The first track 112 and the second track 116 facilitate machine 100's movement. For moving the machine 100, the first track 112 and the second track 116 are powered by the engine 104.

The engine 104 may be a heat engine, or any other source generating power. The engine 104 may include a spark ignited engine, a compression ignited engine. In an embodiment, the engine 104 may be a two stroke engine, a four stroke engine, a six stroke engine, etc.

The engine 104 also provides power to various auxiliary equipment of the machine 100, including the implement 106 for performing work. The implement 106 may be a blade, a bucket, a ripper, a hammer, a grapple or any other suitable implement. A single implement or multiple implements may be attached to machine 100 for performing desired work. In the illustrated embodiment, two implements are attached to the machine 100. One of the implement 106 is a blade attached at a front of the machine 100 while the other implement is a ripper attached to rear of the machine 100.

The engine 104 and all other components of the machine 100 are controlled from the operator station 108, such as by an operator stationed within the operator station 108. The operator station 108 may include a control panel (not shown) for operating the machine 100. The control panel may enable the operator of the machine 100 to control various functionalities of the machine 100. The control panel may include physical controls/levers, and/or touchscreens. The operator station 108, the engine 104, the undercarriage 102, and the implement 106 are coupled to and supported by the assembly 110.

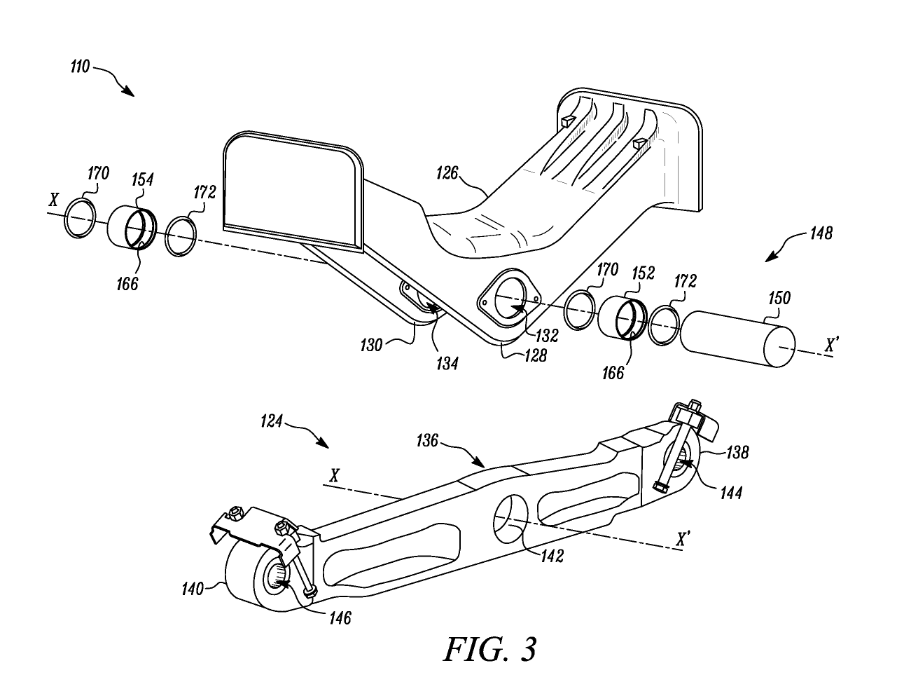

Referring to FIGS. 2 and 3, the assembly 110 includes a main frame 122 and an equalizer bar 124. The main frame 122 includes a saddle member 126. In the illustrated embodiment, the saddle member 126 is extending transverse of the machine 100. The saddle member 126 is laterally extending relative to the main frame 122. The saddle member 126 has an inverted U-shaped cross-section, and includes a first plate 128 and a second plate 130 (best shown in FIG. 3). The first and second plates 128, 130 are laterally spaced from each other. The saddle member 126 further includes one or more bores. For example, the first plate 128 of the saddle member 126 includes a first bore 132 and the second plate 130 of the saddle member 126 includes a second bore 134. The first bore 132 and the second bore 134 are co-axial and defined along a first axis XX′. The first axis XX′ is substantially parallel to the longitudinal axis LL′ of the machine 100. It may be noted that the term substantially parallel is meant to include general manufacturing and other applicable tolerances.

The equalizer bar 124 is positioned transverse of the machine 100. The equalizer bar 124 includes a central portion 136, a first end portion 138, and a second end portion 140. The central portion 136 includes a third bore 142. The first end portion 138 includes a first hole 144 for coupling to the first track frame 114. The second end portion 140 includes a second hole 146 for coupling to the second track frame 118. The equalizer bar 124 is pivotably coupled to the saddle member 126, by an arrangement 148.

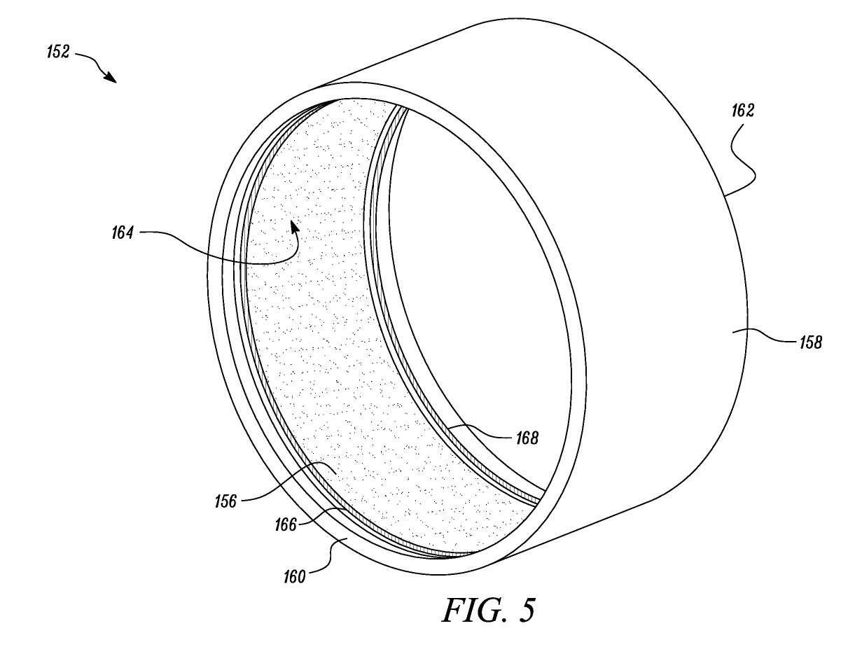

Referring to FIGS. 3, 4, 5, and 6, the arrangement 148 includes a pin 150 and one or more bearings. The one or more bearings, for example, include a first bearing 152 and a second bearing 154. The first bearing 152 may be received in the first bore 132 of the first plate 128. The second bearing 154 may be received in the second bore 134 of the second plate 130. It may be noted that more than one bearings may also be used in a single bore without deviating from the scope of the present invention. In an embodiment, the first bearing 152 may be a self-lubricating bearing. In another embodiment, the first bearing 152 may be a non-metallic bearing. It may be noted that the second bearing 154 is identical to the first bearing 152 in terms of material and physical dimensions.

The first bearing 152 includes one or more axial ends, an inner surface 156, and an outer surface 158. The one or more axial ends include a first axial end 160 and a second axial end 162. The inner surface 156 may include a coating 164, a first groove 166, and a second groove 168. The coating 164 is configured for reducing friction between the inner surface 156 and the pin 150. The coating 164 may include fiberglass, polytetrafluoroethylene or any other suitable lubricant. In an embodiment, the inner surface 156 may be entirely made of the coating 164.

The first groove 166 may provide a seat for a first sealing member 170. The second groove 168 may provide a seat for a second sealing member 172. Thus, the first groove 166 and the second groove 168 may have suitable shapes corresponding to that of the first sealing member 170 and the second sealing member 172, respectively. The first and second sealing members 170, 172 are configured to isolate the inner surface 156 from any impurities, thereby providing effective lubrication. The first and second sealing members 170, 172 may include O-rings and/or any other suitable sealing means.

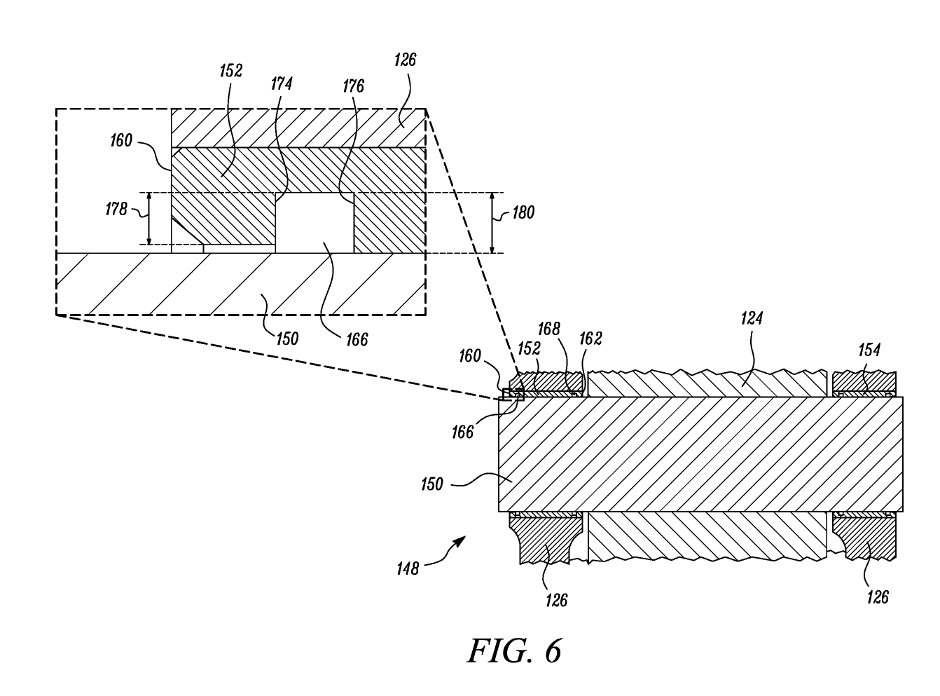

In an embodiment, the first groove 166 and the second groove 168 may be located near the first axial end 160 and the second axial end 162 of the first bearing 152, respectively. Both the first groove 166 and the second groove 168 include a first wall 174 (best shown in FIG. 6) and a second wall 176 (best shown in FIG. 6). The first wall 174 is situated towards the first axial end 160 of the bearing 152 and the second wall 176 is situated towards the second groove 168 of the bearing 152. The first wall 174 has a first height 178 (best shown in FIG. 6) and the second wall 176 has a second height 180 (best shown in FIG. 6), respectively. In an embodiment, the first height 178 may be equal to the second height 180. In the illustrated embodiment, the first height 178 is less than the second height 180. As the first height 178 is less than the second height 180, contact between the pin 150 and the first axial end 160 of the first bearing 152 is avoided, limiting any damage that will be caused at the first axial end 160.

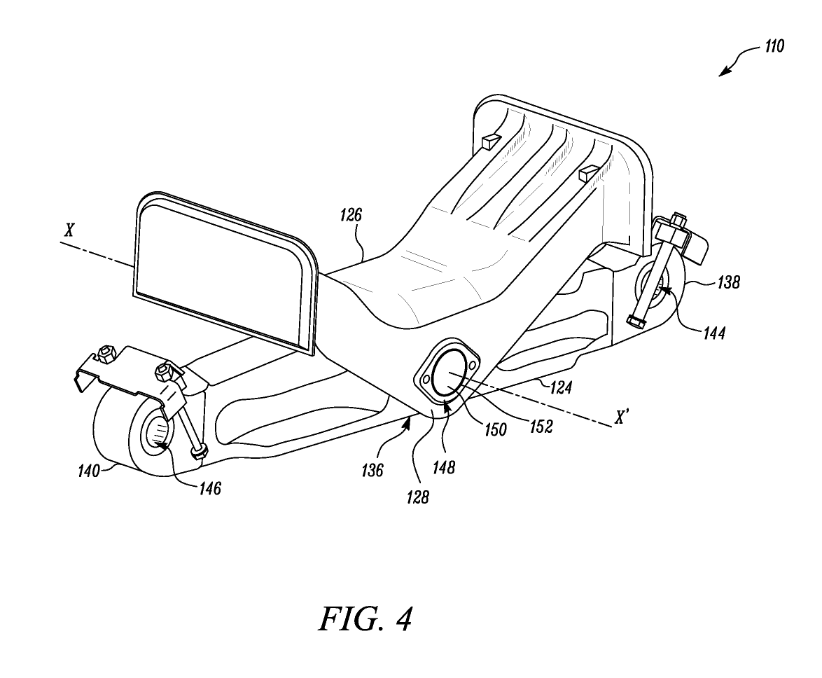

Referring to FIGS. 3 and 4, the pin 150 may be at least partially received and rotatably supported by the first bearing 152 and the second bearing 154. The pin 150 is supported by the first bearing 152 inside the first bore 132 (shown in FIG. 3), and by the second bearing 154 inside the second bore 134. In the assembled position, the equalizer bar 124 is arranged between the first plate 128 and the second plate 130 such that the first bore 132, the second bore 134, and the third bore 142 align with each other along the first axis XX'. The pin 150 extends through the first bore 132, the second bore 134, and the third bore 142 to pivotably couple the equalizer bar 124 with the saddle member 126. Further, the first bearing 152 is positioned inside the first bore 132 and the second bearing 154 is positioned inside the second bore 134 for rotatably supporting the pin 150. The first bearing 152 and the second bearing 154 are press fitted within the first bore 132 and the second bore 134. In the assembled position, the inner surface 156 of the first bearing 152 and an inner surface of the second bearing 154 contacts the pin 150.

### INDUSTRIAL APPLICABILITY

During assembly, an operator (not shown) positions the equalizer bar 124 transverse to the main frame 122 of the machine 100. The operator then places the first bearing 152 and the second bearing 154 inside the first bore 132 and the second bore 134, respectively. In an embodiment, the operator places bearings 152, 154 in position by press-fitting. The operator positions the equalizer bar 124 such that the third bore 142 at the central portion 136 of the equalizer bar 124 aligns with the first bore 132 and the second bore 134 of the saddle member 126. The operator then places the pin 150 inside the first bearing 152, the third bore 142, and the second bearing 154. In an embodiment, the operator places the pin 150 inside in a slip-fit manner.

In operation, the machine 100 encounters uneven terrain during movement. The first track 112 and the second track 116 move up and down while negotiating such terrain. As the first track 112 and the second track 116 are coupled to the equalizer bar 124, the equalizer bar 124 pivots about the pin 150. The pin 150, according to the various embodiments of the present disclosure, is rotatably supported by the bearings 152, 154, thereby avoids jamming due to corrosion. This makes replacement of the pin 150 less cumbersome and effortless. Further, the lubrication in the bearings 152, 154 also makes the replacement of the pin 150 easier and less time consuming.

What is claimed is:

1. An arrangement for pivotally coupling an equalizer bar with a saddle member of a main frame of a machine, the saddle member including one or more bores, the equalizer bar including a central portion, the arrangement comprising:
a pin extending through each of the one or more bores and coupling the saddle member with the central portion of the equalizer bar; and
one or more bearings positioned inside each of the one or more bores for rotatably supporting the pin.

2. The arrangement of claim 1, wherein the one or more bearings include a non-metallic bearing.

3. The arrangement of claim 1, wherein the one or more bearings include an inner surface and an outer surface, wherein the inner surface includes a coating for reducing friction between the inner surface and the pin.

4. The arrangement of claim 3, wherein the coating includes polytetrafluoroethylene.

5. The arrangement of claim 3, wherein the coating includes fiberglass.

6. The arrangement of claim 3, wherein the inner surface of the one or more bearings includes one or more sealing means so that the inner surface is isolated from impurities.

7. The arrangement of claim 1, wherein the machine is a track type machine.

8. The arrangement of claim 1, wherein the one or more bores are co-axial and are defined along a first axis, the first axis being substantially parallel to a longitudinal axis of the machine.

9. An assembly, comprising:
a main frame of a machine, the main frame including a laterally-extending saddle member having a first bore and a second bore;
an equalizer bar having a third bore, whereby the first bore, second bore and the third bore are alignable along a first axis with the third bore positioned between the first bore and the second bore;
a first bearing positioned within the first bore;
a second bearing positioned within the second bore; and
a pin extending in the first axis and at least partially extending in each of the first bearing, the third bore, and the second bearing.

10. The assembly of claim 9, wherein the first bearing and the second bearing include non-metallic bearing.

11. The assembly of claim 9, wherein both the first bearing and the second bearing include an inner surface and an outer surface, wherein the inner surface includes a coating for reducing friction between the inner surface and the pin.

12. The assembly of claim 11, wherein the coating includes polytetrafluoroethylene.

13. The assembly of claim 11, wherein the coating includes fiberglass.

14. The assembly of claim 9, wherein the machine is a track type machine.

15. A machine comprising:
a main frame including a laterally-extending saddle member having one or more bores;
an undercarriage supporting the main frame;
an equalizer bar including a central portion and a pair of distal end portions, the central portion pivotally coupled to the saddle member, and each of the pair of distal end portions coupled to the undercarriage;
one or more bearings positioned inside each of the one or more bores; and
a pin extending through each of the one or more bores and coupling the main frame with the central portion of the equalizer bar.

16. The machine of claim 15, wherein the one or more bearings include non-metallic bearing.

17. The machine of claim 15, wherein the one or more bearings include an inner surface and an outer surface, wherein the inner surface includes a coating for reducing friction between the inner surface and the pin.

18. The machine of claim 17, wherein the coating includes polytetrafluoroethylene.

19. The machine of claim 17, wherein the coating includes fiberglass.

20. The machine of claim 15, wherein the machine is a track type machine.
